(19) United States
(12) Patent Application Publication
(10) Pub. No.: US 2016/0042127 A1
(43) Pub. Date: Feb. 11, 2016

(54) SYSTEM AND METHOD FOR PATIENTS TO PERSONALYSE ANATOMIC CHART IN ELECTRONIC MEDICAL RECORD

(71) Applicant: Durgada V BASAVARAJ, Richmond, VA (US)

(72) Inventor: Durgada V BASAVARAJ, Richmond, VA (US)

(21) Appl. No.: 14/818,319

(22) Filed: Aug. 5, 2015

Related U.S. Application Data
(63) Continuation of application No. 14/580,130, filed on Dec. 22, 2014.
(60) Provisional application No. 62/035,123, filed on Aug. 8, 2014.

(51) Int. Cl. G06F 19/00

(52) U.S. Cl. CPC G06F 19/322

(57) ABSTRACT

The present invention provides a system and method for personalizing a graphic anatomical template into electronic medical (health) record. Accordingly, a system for personalizing an anatomical template into medical record includes a handheld touch screen device and a cloud based server. The handheld touch screen device comprises a display, a camera, a processor, stored anatomical graphic templates, a health care provider engine and a patient engine. A method for personalizing a anatomical template into electronic medical record comprising: patient identification information entry, documenting chief complaints, symptoms and signs about multiple or single part of the body, data entered by the patient comminuting in language selected by the patient at any physical location. Later physician updating information obtained during patient visit, morphing multiple or single part results in to a final personalized pictorial Medical (health) record. Personalized anatomical template pictures added serially over the prior visit documentations for the purpose of comparing to prior visit documentations in the same format, will help assess improvement or worsening of the condition.

### FIELD OF INVENTION

The embodiments herein generally relate to the field of medical records used by physicians. More specifically, the embodiments described herein relate to a system and method for patients to enter data about their medical conditions on a graphic anatomic template in electronic medical record being used by physicians to document medical data of the patient. Particularly, the embodiments described herein relate to a system and method for personalizing a electronic medical record by patients using a graphic anatomic template in medical record for improving accuracy of the medical data even when the patient is a non-English speaking individual instead of a translator, the software itself will pose questions in the language chosen by patient.

### BACKGROUND OF THE INVENTION

Current Electronic medical records being used by physicians and other healthcare providers, is primarily text based. Because of this format, it is difficult for patient to be directly involved in entering their own medical history particularly if they are not fluent in English. health. Moreover, patients and their family also have difficulty in accessing and interpreting text based information which can leads to misunderstanding and poor participation. Although the medical data is provided by the patients about their medical history, is entered into electronic medical record by physicians or their assistants, can be inherently inaccurate. And altering the data is extremely difficult, and if medical treatment is instituted based on inaccuracies, may affect patients adversely.

Anatomical graphic illustrations is available for documenting in electronic medical record. But, for patients to enter their medical conditions and symptoms in a pictorial personalized electronic health record format is not available.

Therefore, there is a need in the art to develop a system and method for personalizing a graphic anatomical template usable by patients to overcome the problem associated with the prior art. Further, there is a need for a system and method for improving access to medical records to assist in taking medical decision by patients and health care providers faster by reviewing pictures rather than reading text. Reviewing medical data in a picture format rather than text documents would be more relevant with mobile devices particularly for first responders.

### SUMMARY

In view of the foregoing, an embodiment herein provides a system and method for personalizing a graphic anatomical template by the patients who are the source of the medical data entered in electronic medical (health) record used by the physicians and other health care providers. A system for personalizing a graphic anatomical Medical (health) care record includes a handheld touch screen device and a cloud based server. The handheld touch screen device comprises a display, a camera, a processor, stored anatomical graphic templates, a health care provider engine and a patient engine.

According to an embodiment, a patient or their surrogate can enter patient identification information. Here, the patient is prompted to choose the sex and the language for entering data then the graphic anatomic model can be opened. The patient is prompted to enter information about their systemic disorders such as diabetes, hypertension, smoking or alcoholism, which can be electronically filled as flashing color letter or a mark on the anatomic template.

In an embodiment, a location of mild severity indication, moderate severity indication and high severity indication can be marked with different intensity of colored pixels Annotations can also be made on the graphic anatomical template if the disease is uncontrolled or stable, with different colored flashing lettering or other mode of graphical markings in the anatomic template, a sound and an image can also be embedded in to graphic anatomical image templates.

According to an embodiment, the patient or health care provider can be prompted to choose sex and age of the body for documentation of patient medical history. Once the particular body template is selected, then most common chief complaints appear in the subsection in the language chosen by patient both in written text and voice format. After selecting the chief complaints, computer logically maps the part of the body to annotate with details of the chief complaints and symptoms related to that part of the anatomical template. Marking/mapping in to the respective subsection of the particular part of the body in the graphic anatomical image templates can be performed. Patients and healthcare providers will have the access to upload pictures obtained by using the camera or any other images to be embedded or to morph that part of the body. Once, that particular part of the body is completed, then the next part of the body is presented to e personalized or any part of the body can be selected to personalize. Text entry can also be recorded in that particular anatomical body.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures the use of the same reference numbers in different figures indicates similar or identical items.

FIG. 1 illustrates a anatomical image template to use for annotation, a choice of sex and age as well as language selected by patient or surrogate, according to an embodiment therein;

FIG. 2 illustrates a anatomical template to enter existing medical history in an image format, according to an embodiment therein;

FIG. 3 illustrates a anatomical image template to enter chief complaints for deciding different parts of the body to be annotated subsequently with symptom and to morph that part of the body by radiological or other images, according to an embodiment therein;

FIG. 4 illustrates a system for personalizing an anatomical template in an electronic medical record, according to an embodiment therein;

FIG. 5 illustrates a system of architecture of the software for personalizing an electronic medical record, according to an embodiment therein;

FIG. 6 illustrates a health care provider module in the system for personalizing an electronic medical record, according to an embodiment therein;

FIG. 7 illustrates a patient module in the system for personalizing an electronic medical record, according to an embodiment therein; and

FIG. 8 illustrates a flowchart for a method for personalizing an electronic medical record, according to an embodiment therein;

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

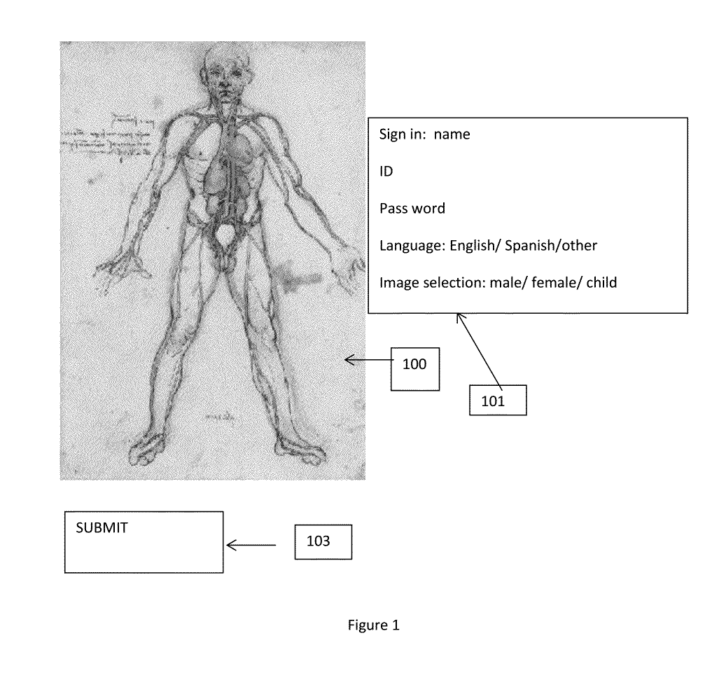

As mentioned above, there remains a need for a system and method for personalizing an electronic medical (health) record easily accessible to patients to enter their medical conditions in any language chosen by the patient or the providers of healthcare, even if both communicates in different languages. The embodiments herein achieve this by providing a system and method which improves access to patients their medical records in a graphic anatomical platform. Referring now to drawings, and more particularly to FIGS. 1 through 8, where similar reference characters denote corresponding features consistently throughout the figures, there are shown preferred embodiments.

According to an embodiment, FIG. 1 illustrates a graphic anatomical image with different sex and age specific template 100. The patient is prompted to enter their authentication data 101; after authentication, demographics and the language for the voice prompted questions 103, is entered. Once this is completed, this will be submitted 104.

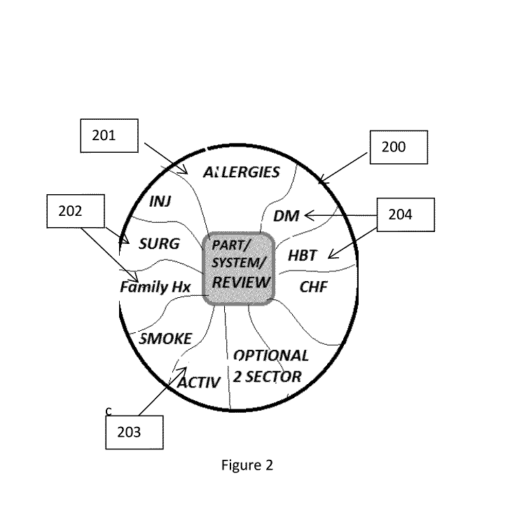

According to an embodiment, FIG. 2, patient will be prompted to answer questions regarding their medical history of allergy 201: prior history of injury, surgery and family history 202; personal history like smoking or alcoholism 203; systemic disorders such as diabetes, hypertension 204 that can be electronically filled and can be changed with gradient of different colors or different density of colored pixels for disease specific identification and marked with mild, moderate and severe degree of the disease by marking with artistic animated letters of different gradients of color.

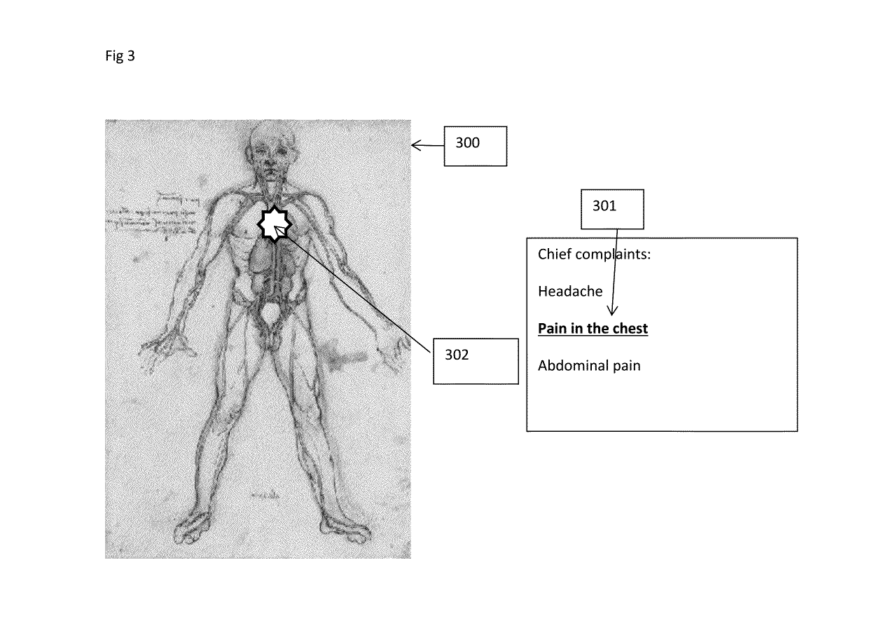

According to an embodiment, in FIG. 3, the patient can be prompted to choose particular part of the body for visit documentation 300. Once that particular part of the body is selected, then most common chief complaints or medical problems patient is seeking evaluation for, like chest pain can be programmed to appear over the graphic anatomical template by using annotation tools 302.

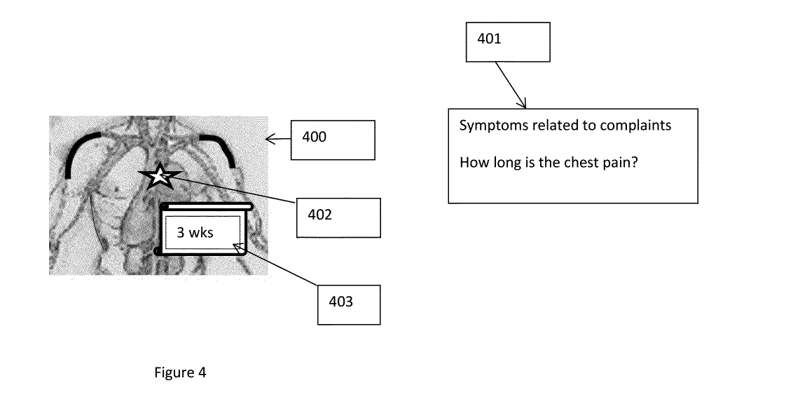

According to an embodiment, FIG. 4 illustrates a graphic anatomical image 400. Logically selected based on the chief complaint 401. That particular part of the body is annotated with tools to mark details of the symptoms either with markings over the anatomical image with pencil tool to map an area, with brush tool to mark location, and lettering to mark severity of mild, moderate or severe degree of symptoms 402, and then the next part of the body can be selected. Text entry can also be recorded at the level of selecting specifically selecting particular part of the body in the sub section 403.

In an example embodiment, “Swelling”, “pain” and “numb” are multiple symptoms. When “swelling” is selected, the screen may prompt to take a picture and the picture of that part to embed and morph that anatomical part from a model to a personalized organ image. When pain is selected the screen may prompt and a brush appears to paint the location of the pain, then color coded to severity of pain. Selecting symptom of “numb” will give the option of pen to map the location of numbness. Duration of symptom is identified with the day or week or month the symptom started. The window appears next to the part to date the onset of symptom. Other information of symptoms like character, continuous or intermittent can be entered in text format and may be recorded permanently in text format embedded in the anatomic template.

In an example embodiment, after the screen of “symptoms” are completed and saved, by the patient, and when they visit physicians or other health care provider can review and update the data entered by the patient and screen with graphic anatomic model for physical abnormality to be updated on that part of the anatomical template. Like tenderness can be mapped over the body color coded to the severity. Abnormal heart sounds are recorded real time in recordable stethoscope and the audio is embedded over the location of the abnormal sounds. Carotid sounds can be recorded and embedded over the carotids. Normal examination of parts and systems can be documented by clicking mouse hovered over that part and right clicking it will mark with lettering next to the sub region of the system and the body part for storing as permanent record as documentation for that visit.

In an example embodiment, updating the diagnostic images like Radiological X-ray of chest may morph the bone structures in the graphic anatomical image of the body into actual radiological images. Clicking on it will bring out the text of the interpretation or the option to enter text information screen either by typing or through dictating software.

In an example embodiment, medical data of multiple or single systems and parts are entered by the patients in their home. Updated by physicians or other providers of care in their office during the patient visit and diagnostic test are uploaded to morph the anatomical template, a final personalized pictorial medical (health) record is the permanent record for that patient visit. This final image can be accessed by the patient in his/her mobile device. In any medical emergency situation, medical information in the form of personalized pictorial Medical (health) record is readily available for first responders. This personalized graphic anatomical image will be categorized based on the date of visit and specialization of physician or other providers of care. After subsequent visits are documented anatomical images can be superimposed over prior image. To correctly identify progress of the condition documented in anatomical platform.

According to an embodiment, the patient can view the personalized graphic anatomical health records for a time period from initial stage and up to recovery. In each stage, health care record can be updated and sounds and images can be uploaded with respect to the electronic health record of the patient.

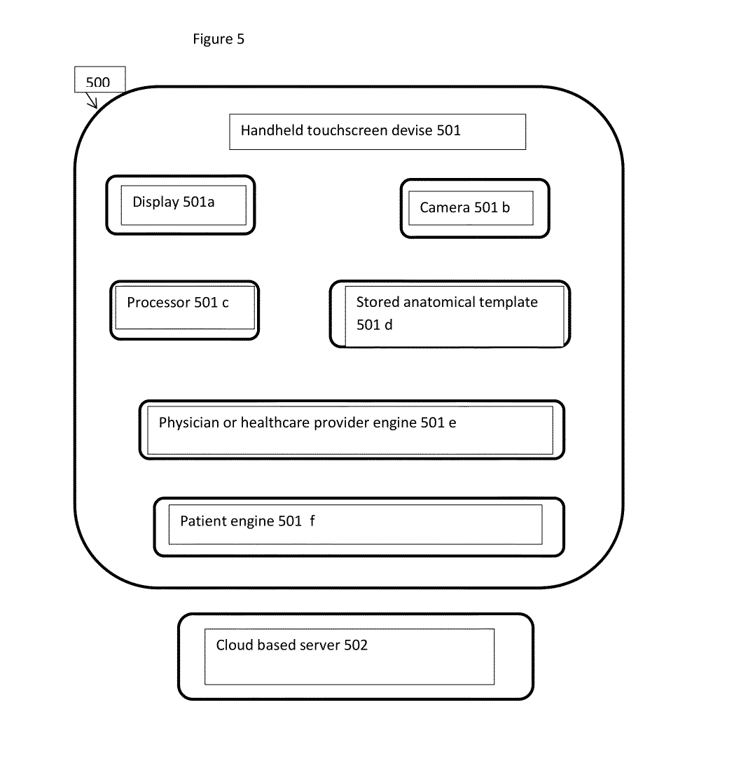

According to an embodiment, FIG. 5 illustrates a system 500 for personalizing an anatomical template in an electronic medical/health record. In an embodiment, the system for personalizing a graphic anatomical medical/health record includes a handheld touch screen device 501 and a cloud based server 502. The handheld touch screen device comprises a display 501a, a camera 501b, a processor 501c, stored anatomical graphic templates 501d, a health care provider engine 501e and a patient engine 501f.

According to an embodiment, the display 501a can be used to access anatomic image of a personalized anatomy. The display of the image can be either in two dimensional or three dimensional digital images. Displaying of the personalized image can be used for the purpose of documenting patient visit evaluation into a electronic medical/health record.

According to an embodiment, the camera 501b can be used to capture real time images of the patients and later, those images can be uploaded to morph that part of the anatomy in the anatomic image templates.

According to an embodiment, the processor 501c includes a logic circuitry that responds to and processes the instruction given by the user (or health care provider). The processor can be designed to execute all the necessary instruction and the respective instruction can be performed to morph the anatomic template.

According to an embodiment, the stored anatomical graphic templates 501d include templates of various parts of the body. The templates can be dynamically modified using a annotation wizard with gradient of different markings or different density of colored pixels to identify various affected parts of the body.

According to an embodiment, the health care provider engine 501e can include necessary modules for performing the necessary operations which includes interface module and other required modules.

According to an embodiment, the patient engine 501f can include necessary modules for performing the necessary operations which includes authentication module and other required modules.

According to an embodiment, the cloud based server 502 can store anatomical images as a template and it is capable of accepting request from the client and gives responses accordingly.

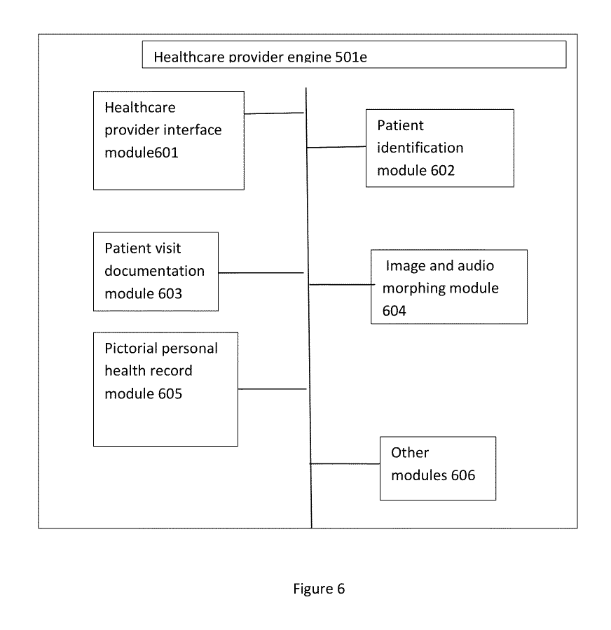

FIG. 6 illustrates a health care provider engine in the system for personalizing an anatomical graphic image into electronic medical (health) record, according to an embodiment. The health care provider module 501e includes health care provider interface module 601, patient identification module 602, patient visit documentation module 603, morphing/embedding image and audio module 604, pictorial personalized Medical (health) record module 605 and other modules 606.

According to an embodiment, health care provider interface module 601 forms as an interface between the health care provider and the patient. The health care provider interface module can act as a shared boundary across the health care provider and the patient for exchanging information.

In an embodiment, the patient identification module 602 includes all the required patient information which can be collected by the health care provider. The patient information module includes primary information of patients such as all the basic information of the patients and the symptoms of diseases and other information.

According to an embodiment, the patient visit documentation module 603 used by the health care provider utilizes the anatomic image template which is updated with the chief complaints, diseases and symptoms entered by the patient. Based on the information provided in the personalized anatomic image document of the particular patient, the health care provider can evaluate, update anatomical template with clinical examination arrive at a diagnosis and enter treatment plan for the patients.

According to an embodiment, the image obtained from provider module to morph the anatomical template and audio module 604 supports to upload the concerned images and sounds to be inserted in to the anatomic image templates. Further, the images and sounds morphed or morphing the anatomic image template information can be updated.

In an embodiment, the pictorial personalized electronic health care module 605 is a collection of personalized annotations and entry in the format of anatomical medical records of patients. This electronic medical record is easily accessible to patients, first responders and other providers of healthcare for that particular patient. This electronic medical record in picture format provides all the necessary information with respect to the patient evaluations and thereby improves information availability for improving quality of medical care.

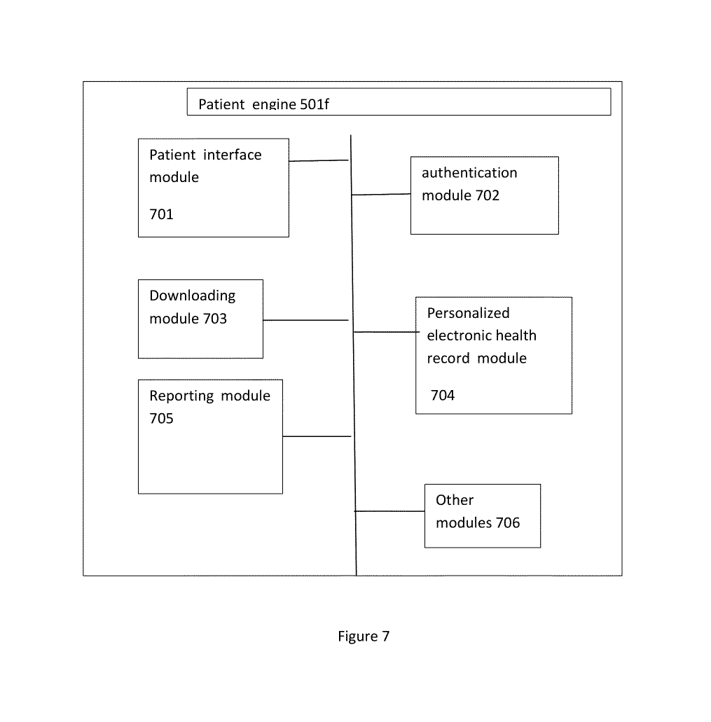

FIG. 7 illustrates a patient module in the system for personalizing a graphic anatomical template as a electronic medical (health) record, according to an embodiment. The patient module 501f includes patient interface module 701, authentication module 702, downloading module 703, personalized health record module 704, reporting module 705 and other modules 706.

According to an embodiment, the patient interface module 701 forms as an interface between the patient and the health care provider. The patient interface module can act as a shared boundary across the health care provider and the patient for exchanging information.

According to an embodiment, the authentication module 702 provides security to the anatomic template which can be protected in the form of biometric and barcode verification.

According to an embodiment, the downloading module 703 can supports for downloading the images and sounds that and all necessary for morphing in to the anatomic templates. Further, the downloading module supports for downloads and keeps necessary images and sounds to be saved in to mobile device.

According to an embodiment, the pictorial personalized health care module 704 is a collection of personalized content of medical records of patient data entered by the patients and the physicians or other healthcare worker. It is programmed to interact with patients in different languages in text, audio or visual medium. This medical record is easily accessible and provides all the necessary information with respect to the patient disease and thereby improves access and participation in entering data into the electronic medical records.

In an embodiment, the reporting module 705 can be used to give feedback about the personalized electronic medical records and may also be utilized to report the problems associated with the personalized medical records.

In an example embodiment, a system and a method for personalizing a the health record graphic anatomical template based with very minimal text based information demanding less time spent in reviewing as well as a medium for better understanding. The system and method for personalized anatomical electronic medical (health) record facilitates easer understanding and sharing of the information by the patient. When patients are full participant in decision making based on accurate and understandable medium (personalized pictorial electronic medical record). More over all this is easily available to the patient to be downloaded into their mobile device which is secured with biometric validation. When patient encounter's an emergency medical situation, most of the medical information is available to the first responders in a pictorial, audio visual medium of the patients personalized pictorial anatomical image.

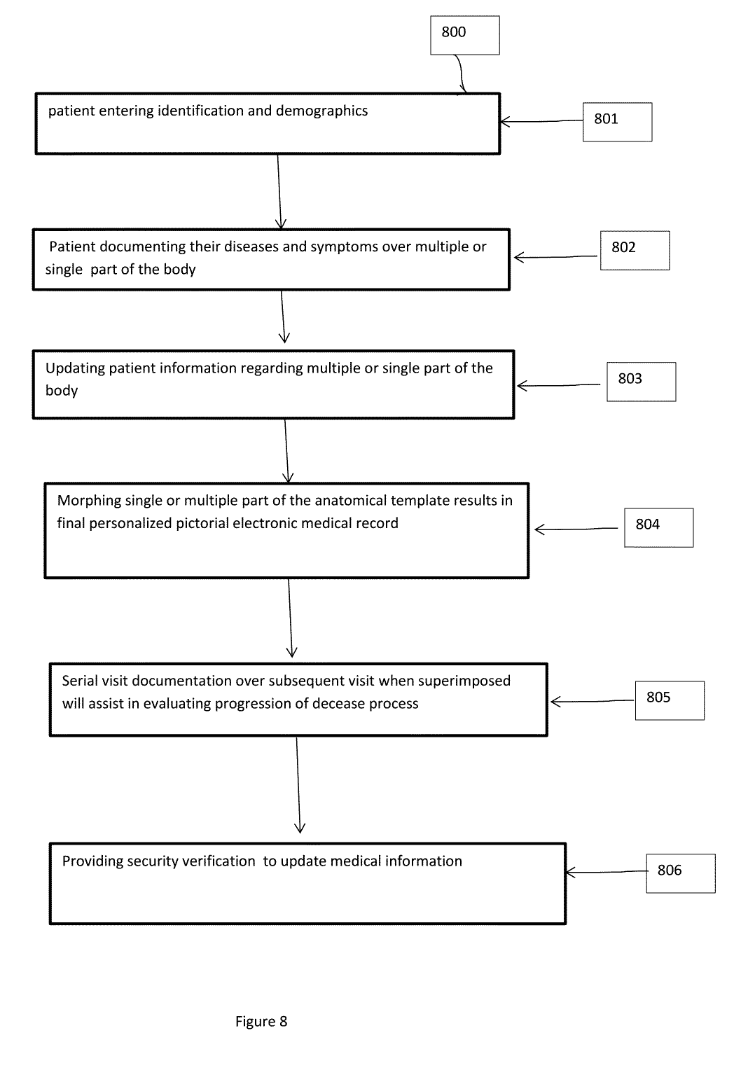

FIG. 8 illustrates a flowchart for a method for personalizing a health record, according to an embodiment. The method for personalizing a electronic Medical (health) record includes entering patient identification information 801, documenting of chief complaints, medical history of diseases, symptoms and signs over multiple or single part of the body 802, updating patient visit information regarding multiple or single part of the body 803, morphing multiple or single part results in to a final personalized pictorial electronic health record 804, personalizing subsequent visit documentation into anatomical template to be added serially over the prior visit documentation 805 and providing security verification to update medical information 806.

At block 801, entering patient identification information can be performed. The patient information includes all the basic information of the patients. The patient can enter and confirm all their identification information which includes all their basic information.

At block 802, diagnosing multiple or single part of the body can be performed. In this block, the patient can enter all the specific details related to the particular part of the body. Initially, subsections related to the particular part of the body is logically offered or can be opened and in that the patient can select the necessary parts and then can document the diseases and symptoms.

At block 803, updating more information regarding multiple or single part of the body can be performed by the physician or healthcare workers. Signs and physical examination can be updated with respect to the particular multiple or single part of the body. Updated medical information can include images or sounds.

At block 804, morphing multiple or single part or organ results in to a final personalized pictorial electronic health record. Here, updated medical information can include images or sounds.

At block 805, personalizing pictorial digital anatomical electronic medical record. Then the pictures can be superimposed to aid in comparison. This implies that the more updated information with the combination of symptoms, sounds and images can be present in personalized medical record.

At block 806, providing security verification to update medical information. Biometric and barcode security information can be provided in to mobile device in order to update the medical information.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system for personalizing a graphic anatomical template into Electronic Medical (health) care record comprising:
a handheld touch screen device having a display, a camera, a processor, stored anatomical graphic templates, a health care provider engine and a patient engine; and
a cloud based server for storing an anatomical image and annotation wizard.

2. The system of claim 1, wherein said health care provider engine includes health care provider interface module, patient identification module, patient visit documentation module, morphing image and audio module, pictorial personalized health record module and other modules.

3. The system of claim 1, wherein said patient engine includes patient interface module, authentication module, downloading module, personalized Medical (health) record module, reporting module and other modules.

4. The system of claim 1, wherein said cloud based server store digital human anatomical image template for personalizing said image in to an Electronic medical (health) record.

5. The system of claim 1, wherein said system improves access to medical records and facilitates participation by the patients so patient can directly enter their medical history into the anatomical template in any language.

6. A method for personalizing a digital anatomical medical (health) care record comprising:
entering patient identification information in a anatomic template, documenting normal as well as abnormal findings in the form of annotations on multiple or single part of the body. This data entry can be performed by patient, or their surrogate in their own location the questions will be prompted by the software either in text, audio or visual medium in any selected language to annotate on the anatomical template. updating patient visit information performed by physician or other healthcare provider regarding multiple or single part of the body, morphing multiple or single part of the body by using pictures or radiological images performed by physicians. Morphing anatomic template results in to a final personalized pictorial health record. Serial personalized anatomic electronic medical records with subsequent visit documentation to be superimposed to document progress of the medical condition.

7. The method of claim 6, wherein a health care provider enters patient identification information.

8. The method of claim 6, wherein a medical condition of mild indication, moderate indication and high indication of severity can be annotated with different intensity of colored pixels or markings on the anatomical template at the time of entering data into parts of the body.

9. The method of claim 6, wherein said pictures and images to morph anatomical template to personalize the anatomical template into personalized anatomical electronic medical record.

10. The method of claim 6, wherein said morphing the anatomic template with sounds and images gives audio visual understanding of particular patient visit documentation while text entry can also be recorded embedded in appropriate part of the body.
